(19) United States
(12) Patent Application Publication
(10) Pub. No.: US 2009/0248835 A1
(43) Pub. Date: Oct. 1, 2009

(54) OFFLOADING DATA TRANSFERS BETWEEN A LOCAL AND REMOTE NETWORK

(76) Inventors: Subhankar Panda, Penang (MY); Yong Joo Lee, Melaka (MY)

Correspondence Address: INTEL CORPORATION;c/o CPA Global, P.O. BOX 52050, MINNEAPOLIS, MN, 55402, US

(21) Appl. No.: 12/059,367

(22) Filed: Mar. 31, 2008

(51) Int. Cl. G06F 15/16

(52) U.S. Cl. 709/218

(57) ABSTRACT

A method, system, and computer readable medium are disclosed. In one embodiment the method includes initiating a data transfer from a first computing device to a second computing device. Then the method continues by designating a third computing device to offload at least a portion of the data associated with the data transfer. Additionally, the method stores the offloaded portion of the data on the designated third computing device for a period of time. Finally, the method concludes by sending the data stored on the third computing device to the second computing device after the period of time.

### FIELD OF THE INVENTION

The invention relates to offloading data transfers between a local network and a remote network.

### BACKGROUND OF THE INVENTION

A computer system within a digital home network generally has Internet access through a gateway or router. The computer system may be one of several computing devices coupled to the digital home network. For example, a digital home network may have a broadband gateway device that is coupled to a device that provides a broadband Internet connection, such as a digital subscriber line (DSL) modem or a digital cable modem, among others.

The broadband gateway device may have router or switch capabilities that allow several home computing devices to connect, through the digital home network, to the Internet connection. Some devices that may utilize the Internet through the broadband gateway device are desktop computers, laptop computers, personal digital assistants (PDAs), handheld gaming devices, television set top boxes, and general gaming consoles, among other potential devices. One consequence of having a number of these devices is that each one takes significant power to run (e.g. a desktop computer commonly has a several hundred watt power supply that is fully powered when the computer is performing standard tasks including uploading and downloading data to and from the Internet).

Although broadband connection speeds have gone up substantially in recent years, the complexity of the content that a given home user may want to upload to the Internet or download from the Internet has risen as well. Thus, high definition (HD) movies, games, and other high end content may still require lengthy download or upload times. Additionally, upload speeds usually are more limited with many high speed Internet connections than download speeds. So distributing multimedia content from a person's home to the Internet might create significant upload times.

### BRIEF DESCRIPTION OF THE DRAWINGS

The present invention is illustrated by way of example and is not limited by the drawings, in which like references indicate similar elements, and in which:

FIG. 1 describes an embodiment of a system for offloading data transfers in a networking environment.

FIG. 2 illustrates a flow diagram of one embodiment of a process to offload a portion of a data transfer from a first computer to a remote network.

FIG. 3 illustrates a flow diagram of another embodiment of a process to offload a portion of a data transfer from a first computer to a remote network.

FIG. 4 illustrates a flow diagram of yet another embodiment of a process to offload a portion of a data transfer from a first computer to a remote network.

FIG. 5 illustrates a flow diagram of an embodiment of a process to offload a portion of a data transfer from a remote network to a first computer.

### DETAILED DESCRIPTION OF THE INVENTION

Embodiments of a method, system, and computer readable medium for offloading data transfers in a networking environment are disclosed. Many of the embodiments disclosed involve a computing device coupled to a digital home network that initiates either a download of data from a remote location on the Internet or initiates an upload of data to a remote location on the Internet. Once the data transfer is initiated by the first computing device, a second computing device, also coupled to the digital home network, is designated a data transfer offload device. Then once the designation takes place, the remainder of the data involved in the data transfer may be received or sent by the data transfer offload device. Examples of the data transfer offload device could be the broadband gateway device or another computer system located in the digital home network.

In the case of a download from the Internet, the data transfer offload device can then receive the remainder of the data associated with the initiated data transfer and store the received data to a storage unit within the device or elsewhere. During this time, the computer that initiated the download no longer needs to remain operational (e.g. powered on). Instead, the broadband gateway device or other computer system in the digital home network can receive and store the remainder of the data associated with the data transfer. Then at a later time, the stored data can be eventually copied over the digital home network to the initiating computer. This later time can take place as a result of any one of a number of events such as the initiating computer system being powered on again, or the user at the initiating computer sending a request to the data transfer offload device to receive the data, among other events.

Thus, the download from the Internet can still take place uninterrupted from the point it was initiated. Only now, the initiating device has no state requirement during download after the data transfer offload device has been designated.

This same situation can be utilized in a data upload situation as well. For example, the initiating computer system may initiate an upload, then designate the data transfer offload device, copy the remainder of the data that hasn't yet transferred to the data transfer offload device, and allow the offload device to complete the remainder of the upload. This can be especially advantageous when the data transfer speed of the digital home network is significantly superior to the data transfer speed of the broadband Internet connection.

Reference in the following description and claims to “one embodiment” or “an embodiment” of the disclosed techniques means that a particular feature, structure, or characteristic described in connection with the embodiment is included in at least one embodiment of the disclosed techniques. Thus, the appearances of the phrase “in one embodiment” appearing in various places throughout the specification are not necessarily all referring to the same embodiment.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

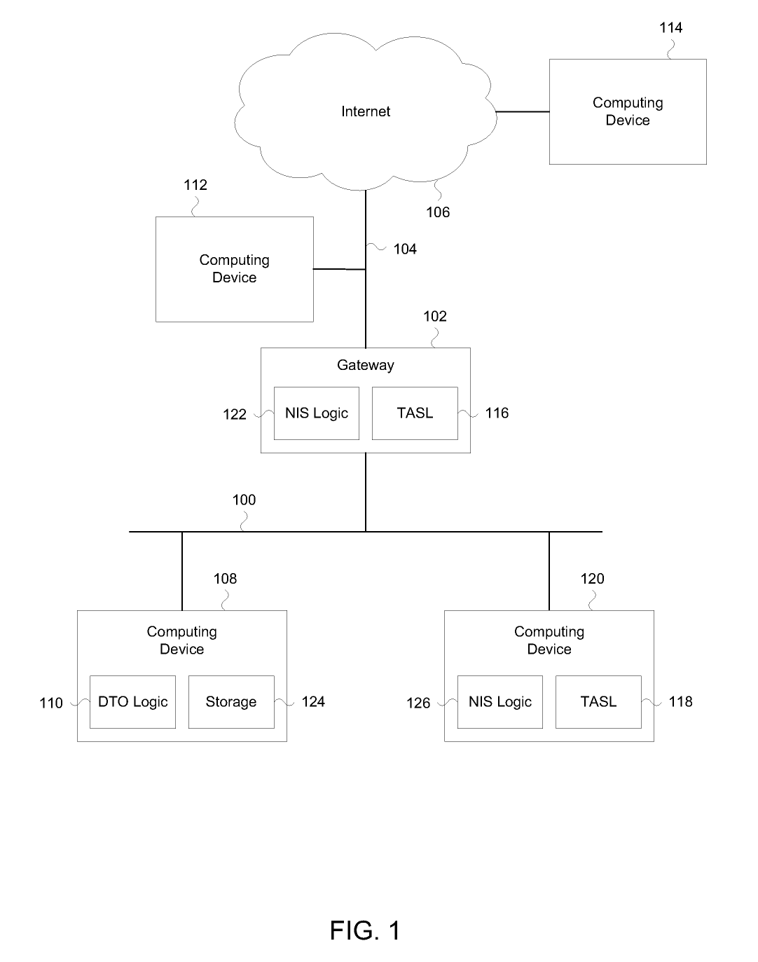

FIG. 1 describes an embodiment of a system for offloading data transfers in a networking environment. The system includes a local area network (LAN) 100 in many embodiments. In different embodiments, the LAN 100 may be a network within a home networking environment, a network within a business networking environment, or any other potential local area networking solution utilized in a public or private environment. The LAN may utilize transport communication protocol/Internet protocol (TCP/IP) or another standard packet transportation protocol.

In many embodiments, the LAN 100 is communicatively coupled to a gateway device 102. In different embodiments, the coupling may include a wired solution, such as an Ethernet cable, or a wireless solution such as a wireless protocol (e.g. the IEEE 802.11 series of wireless protocols). In some embodiments, the gateway 102 is communicatively coupled to a wide area network 104. In different embodiments, the wide area network may utilize one of a number of different topologies and protocols such as a traditional WAN, a WiMAX (worldwide interoperability for microwave access), a digital subscriber line (DSL), broadband cable, or one of a number of other possible wide area network-type topologies and protocols. The gateway 102 may include standard routing and bridging circuitry to allow network communications and data transfers to occur between the LAN 100 and the wide area network 104.

In other embodiments, the gateway 102 is communicatively coupled to the wide area network 104 through a modem (not pictured). In embodiments that utilize wide area network topologies through DSL, cable modems, and similar solutions, a modem may be utilized for conversion purposes. E.g. to convert a DSL or broadband cable protocol on a phone line or cable line, respectively, to standard networking packets such as those that utilize TCP/IP. In yet other embodiments, the converting modem is integrated into the gateway 102. Additionally, in many embodiments, the wide area network 104 is communicatively coupled to the Internet 106.

Returning to the LAN 100, in many embodiments, one or more computing devices may be communicatively coupled to the LAN 100 such as desktop computers, laptop computers, personal digital assistants (PDAs), handheld gaming devices, television set top boxes, and general gaming consoles, among other potential devices. The coupling these devices have with the LAN 100 may be wired (such as Ethernet) or wireless (such through an IEEE 802.11 wireless protocol). Alternatively, one or more of the computing devices may be communicatively coupled to the LAN 100 through an additional device (e.g. an additional router). Each of these computing devices may include one or more processors, memory, storage, video peripherals, keyboards, mice, remote controls, and other such hardware and peripheral arrangements.

In many embodiments, computing device 108 includes data transfer offloading (DTO) logic 110. The DTO logic 110 may perform certain functions to alleviate a data transfer between computing device 108 and a (address) location external to the LAN 100. The location external to the LAN 100 such as a computing device coupled to the wide area network 104 (computing device 112) or a computing device somewhere else on the Internet 106 (computing device 114). In some embodiments, the computing device (112 or 114) external to the LAN 100 may be a server, another desktop computer, or another form of computing-related equipment. In some embodiments, the external computing device (112 or 114) may be communicatively coupled directly to the wide area network 104 and/or the Internet 106. In other embodiments, the external computing device (112 or 114) may be communicatively coupled to the wide area network 104 and/or the Internet 106 through one or more other devices such as switches, routers, gateways, etc. In other embodiments (not shown), the computing devices external to the LAN 100 may be coupled to another LAN.

Since each external computing device is external to the LAN 100, these external computing devices may be referred to as being coupled to a “remote” network. Alternatively, computing device 108 and any other computing device communicatively coupled directly to, or through a local device (such as a router connected to LAN 100), LAN 100 may be referred to as being coupled to the “local” network.

Thus, DTO logic 110, or other logic on computing device 108, may initiate a data transfer between computing device 108 and an address location within a remote network (e.g. the address location of computing device 114). The data transfer may be initiated through standard communication protocols such as TCP/IP, TFTP (trivial file transfer protocol), FTP (file transfer protocol), or any other potential data transport protocol. Apart from initiating the data transfer, DTO logic 110 within computing device 108 also designates a temporary alternative storage location (TASL) for at least a portion of the data that is associated with the data transfer. In some embodiments, the designation happens automatically due to some issue with the data itself (e.g. such as the file being over a certain size threshold). In other embodiments, a user at the computing device interacts with an interface that is part of the DTO logic 110 within computing device 108. The user may specify the location of the TASL if multiple candidate locations exist.

In some embodiments, the TASL (TASL 116) is located within gateway 102 (TASL 116). In other embodiments the TASL (TASL 118) is located within another computing device (computing device 120) communicatively coupled to the local network (LAN 100). In some embodiments, the TASL is located internally within the gateway 102 or computing device 120, such as a hard disk drive (HDD). In other embodiments (not shown), the TASL is located in a device coupled externally to the gateway 102 or computing device 120, such as a Universal Serial Bus (USB)-based thumb drive or a network storage solution.

In the example that the gateway 102 houses the TASL (TASL 116), the gateway 102 also would include network intermediary storage (NIS) logic 122 to receive the designation as well as to initiate the capture of subsequent data packet transfers associated with the data transfer initiated by computing device 108. The NIS logic 122 would receive subsequent data that was originally bound for computing device 108 as part of the data transfer and store this data within the TASL 116. This temporary storage process would take place for a period of time until computing device 108 was ready to receive the data from the TASL 116. At that time, NIS logic would send the stored data to computing device 108. In many embodiments, computing device 108 includes storage unit 124 to store portions or all of the data associated with the data transfer.

There may be many and varied reasons why computing device 108 has portions or all of the data transfer temporarily stored on another computing device such as gateway 102. For example, gateway 102 may consume much less power than computing device 108. Furthermore, the LAN 100 connection speed may far surpass the wide area network 104 connection speed. Overall power consumption for the LAN 100 (local network) and all computing devices coupled to it may be lowered if higher power consuming computing systems (e.g. computing device 108) are powered down during a long slow data transfer from a remote network to the LAN 100. Whereas, lower power consuming computing systems (e.g. gateway 102) are left powered on to complete the transfer from the remote network to the local network. Once the data transfer has completed to the temporary storage location in gateway 102, the remote network no longer may dictate the speed of the data transfer. Thus, computing system 108 may then be powered back on to subsequently receive portions or all of the data associated with the data transfer from gateway 102.

Another possible reason for designating an alternative computing device with a TASL to receive files may be related to performance impact. If computing device 108 has a heavy workload, such as a heavy network workload between itself and another computing device (e.g computing device 120), then computing device 108 can designate an alternative computing device with a TASL to receive files from a remote network. This can alleviate the performance impact multiple heavy download workloads may require. Again, once computing device 108 has been freed up, it can then receive the portion or all of the data transfer temporarily stored within TASL 116 in gateway 102.

In some embodiments, a user of computing device 108 may determine when data associated with a data transfer stored temporarily within TASL 116 on gateway 102 would be transferred to the original destination on computing device 108. In other embodiments, portions of DTO logic 110 may make an automatic determination as to when it would be beneficial to receive the temporarily stored data. The automatic determination may be based on DTO logic 110 within computing device 108 querying NIS logic 122 within gateway 102 as to whether the data transfer has completed from the remote network and TASL 116 currently stores the portion or all of the data associated with the data transfer. Where a user of computing device 108 makes the determination when the data is transferred, the user may manually query, through a user interface associated with DTO logic 110, when the transfer of data from the remote network to the TASL 116 has completed. In any event, a period of time may pass between when data associated with a data transfer is stored within a TASL and when that temporarily stored data is then eventually sent on to the original initiator of the data transfer (e.g. computing device 108).

In many other embodiments, the initiated data transfer is in the opposite direction, for example, from computing device 108 to computing device 112 coupled to wide area network 104 (a remote network). Again, in situations where the data transfer rate within LAN 100 (the local network) exceeds the data transfer rate of a remote network, it may be beneficial to utilize a TASL that is coupled to the local network. An example again may be TASL 116 within gateway 102. The data transfer may be initiated between computing device 108 and computing device 112 and then either immediately or at some point in time thereafter, while the data transfer is still taking place, TASL 116 may be designated as a location to store all of or the remaining portion of the data associated with this data transfer. In this situation, DTO logic 110 will designate the TASL 116 within gateway 102 and then send a portion or all of the data to TASL 116. At some point thereafter, once this temporary transfer has completed, NIS logic 122 within gateway 102 will then send the data stored temporarily within TASL 116 to computing device 112.

The transfer methodology can take different forms depending on the logic within each computing device involved in the transfer. For example, in some embodiments, a transfer from a computing device on a remote network to a computing device on a local network (e.g. computing device 108) where a portion, but not all, of the data associated with the transfer is temporarily stored within TASL 116 in gateway 102, may require copying the portion of the data not stored within TASL 116 (the portion that was copied to the original destination already, potentially being stored within storage 124) back to TASL 116. This would allow the TASL 116 to have a complete copy of the data rather than just a partial copy. In other embodiments, the DTO logic 110 within computing device 108 may allow retaining the already copied portion of the data to remain within storage 124. In these embodiments, once the remainder of the data is stored within TASL 116, that portion of the data can be then sent to computing device 108 and DTO logic 110 may combine the sent data with the portion of the data stored within storage 124 to construct a complete copy of the data at the final destination, computing device 108.

In other embodiments, the transfer can comprise three or more stages. For example, a transfer of data may be initiated from a remote network to computing device 108. After a period of time (where a first portion of the data has already arrived at computing device 108 and stored within storage 124) and while the transfer is still taking place, the transfer may be offloaded to gateway 102 where a second portion of the data is stored within TASL 116. After a further period of time while the transfer is still taking place, computing device 108 can again start receiving a third remaining portion of the data directly from the remote network.

In this example, the first and third portions of the data associated with the data transfer are stored within storage 124 on computing device 108 and the second portion of the data associated with the data transfer is stored in TASL 116. In some embodiments, this data can remain in these portions until the transfer has completed from the remote network and then any portions of the data not already stored at the destination (i.e. the second portion stored in TASL 116) can be sent to computing device 108 and DTO logic 110 can construct the complete data from all three portions. In other embodiments, as soon as the data transfer target switches (e.g. from computing device 108 to gateway 102), the current target obtains copies of any portions of the data associated with the data transfer it does not currently have that were already transferred from the remote network. In these embodiments, the current target destination, whether that is the original destination or the designated temporary destination, will have or strive to have all portions of the data that have been already transferred from the remote network.

Additionally, the local network transfers either from TASL 116 to storage 124 or vice versa may be accomplished through a querying system. Due to the fact that computing device 108 may be non-functional (e.g. powered down) during portions of the data transfer that are being sent from the remote network to the TASL 116, once the data transfer from the remote network has completed, in some embodiments, NIS logic 122 within gateway 102 may proactively query computing device 108 (and DTO logic 110 within it) as to the availability of computing device 108. Computing device 108 may not be available due to being powered down, in a low power state, in a boot up or error-related stage and not fully functional, or just busy with other tasks (i.e. computing device 108 is too busy to receive the data from TASL 116 and does not approve of the subsequent data transfer across the local network).

In embodiments where NIS logic 122 is proactive to complete the transfer to the original destination, NIS logic 122 may query DTO logic 110 to determine when computing device 108 is available to receive the data stored within TASL 116. This may be referred to as “push” logic. Alternatively, in other embodiments, DTO logic 110 may be proactive in determining when the transfer from the remote network has completed. In these embodiments, DTO logic 110 may query NIS logic 122 to determine when the transfer has completed from the remote network and request receiving the data stored in TASL 116 once the original transfer from the remote network has been verified as complete. This may be referred to as “pull” logic. In yet other embodiments, a user of computing device 108 may utilize a user interface associated with DTO logic 110 to perform the query of NIS logic 122 and manually request the data from TASL 116.

Although, examples described above were in reference to gateway 102 with TASL 116 as being the designated location of the temporary storage, this is not necessarily the case in all embodiments. Rather, in other embodiments, another computing device coupled to LAN 100 may be designated as the device for the TASL (such as computing device 120 with TASL 118 and NIS logic 126). Computing device 120 may be equally as capable of providing temporary storage as gateway 102 with all the same functionality. Similarly, computing device 120 may also want to utilize another computing device's storage space as temporary space for data transfers between itself and a remote network. Thus, although not shown, computing device 120 may also have DTO logic and a storage unit (with the same functionality as DTO logic 110 and storage unit 124). In these embodiments, computing device 108 may also accordingly have NIS logic and a TASL (with the same functionality as NIS logic 126 and TASL 118).

In many embodiments, data copied within LAN 100 from one device to a second device may be deleted on the origination device that are both coupled to LAN storage space amongst computing devices coupled to LAN 100. Once data associated with the data transfer is sent from one local computing device to another (e.g. from gateway 102 to computing device 108), the data that was sent is subsequently erased from the sending device's storage space. Thus, if a portion of the data associated with a data transfer from a remote network to computing device 108 is stored within TASL 116 in gateway 102, when that stored data is successfully sent from TASL 116 to storage unit 124, the copy of the data within TASL 116 may be deleted in many embodiments.

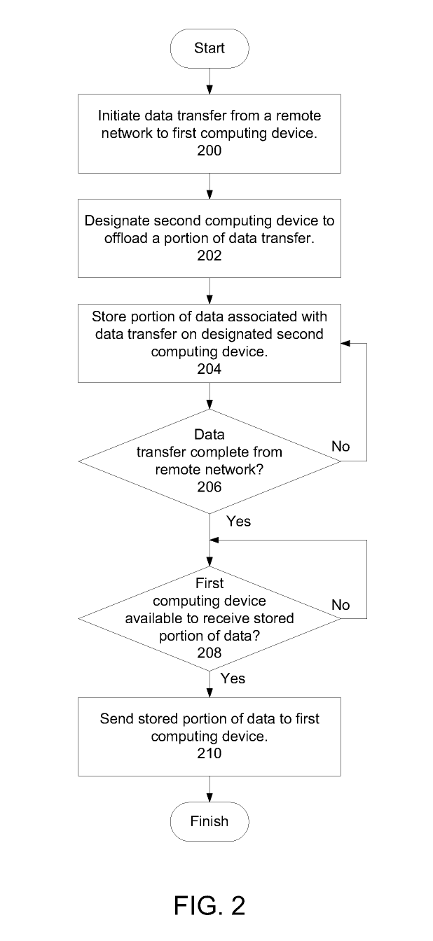

FIG. 2 illustrates a flow diagram of one embodiment of a process to offload a portion of a data transfer from a first computer to a remote network. The process may be performed by processing logic that is comprised of hardware, software, or a combination of both. Turning now to FIG. 2, the process begins by processing logic initiating a data transfer from a remote network to a first computing device (processing block 200). In many embodiments, the data transfer is specifically between the first computing device, which may be coupled to a local network, and a remote computing device coupled to the remote network.

The process continues by processing logic designating a second computing device to offload a portion of the data transfer (processing block 202). Processing logic then stores a portion of the data associated with the data transfer on the designated second computing device (processing block 204). Next, in many embodiments, processing logic determines whether the data transfer has completed from the remote network (processing block 206). If not, processing logic returns to block 204 to continue storing the portion of the data on the second computing device.

Otherwise, if the data transfer has completed, then processing logic checks to see if the first computing device is available to receive the stored portion of the data (processing block 208). If not, processing logic waits until the first computing device is available. Once the first computing device is available, processing logic then sends the stored portion of the data to the first computing device (processing block 210) and the process is finished.

The embodiment shown in FIG. 2 is a “push” logic implementation because processing logic within the second computing device actively seeks to push the data it has temporarily stored to the original destination (this is shown specifically in blocks 208 and 210). In other embodiments that are not shown in FIG. 2, but equally functional, a “pull” logic implementation may be utilized where the first computing device queries the second computing device to determine if the second computing device is done receiving data. Then, once the second computing device is done, the first computing device actively requests to receive the temporarily stored data from the second computing device.

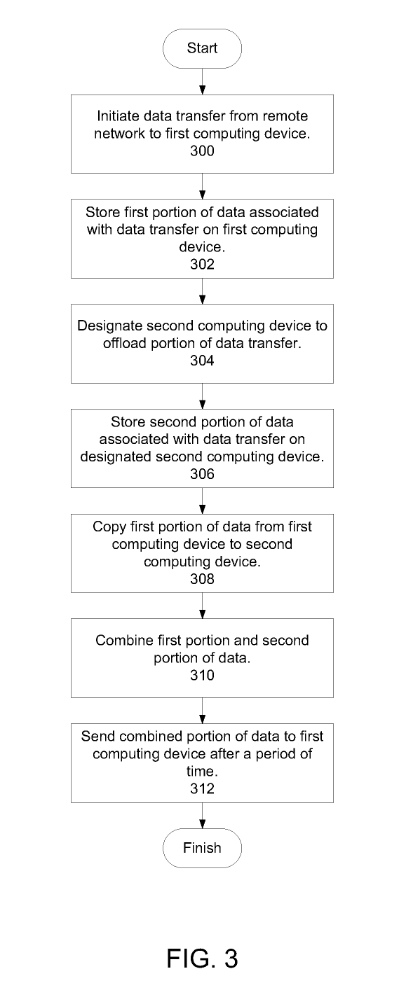

FIG. 3 illustrates a flow diagram of another embodiment of a process to offload a portion of a data transfer from a first computer to a remote network. The process may be performed by processing logic that is comprised of hardware, software, or a combination of both. Turning now to FIG. 3, the process begins by processing logic initiating a data transfer from a remote network to a first computing device (processing block 300). In many embodiments, the data transfer is specifically between the first computing device, which may be coupled to a local network, and a remote computing device coupled to the remote network.

Processing logic then stores a first portion of the data associated with the data transfer on the first computing device (processing block 302). Processing block 302 takes place prior to any offload designation, thus this would be the standard process if no offloading occurred. Then processing logic designates a second computing device to offload a portion of the data transfer (processing block 304). Next, processing logic stores a second portion of the data on the designated second computing device (processing block 306). Thus, at this point, different portions of the data associated with the data transfer are located on both the first and second computing devices. Then, in some embodiments, processing logic copies the first portion of the data from the first computing device to the second computing device (processing block 308). Next, processing logic combines the first portion and second portion of the data (processing block 310). This combination allows the data to be stored in one location instead of being fragmented across the two computing devices.

Processing logic then sends the combined portion of the data to the first computing device after a period of time (processing block 312) and the process is finished. In some embodiments, the period of time coincides with a period of time that the first computing device is unavailable. In other embodiments, the period of time ends when a user utilizing the first computing device requests the data from the second computing device.

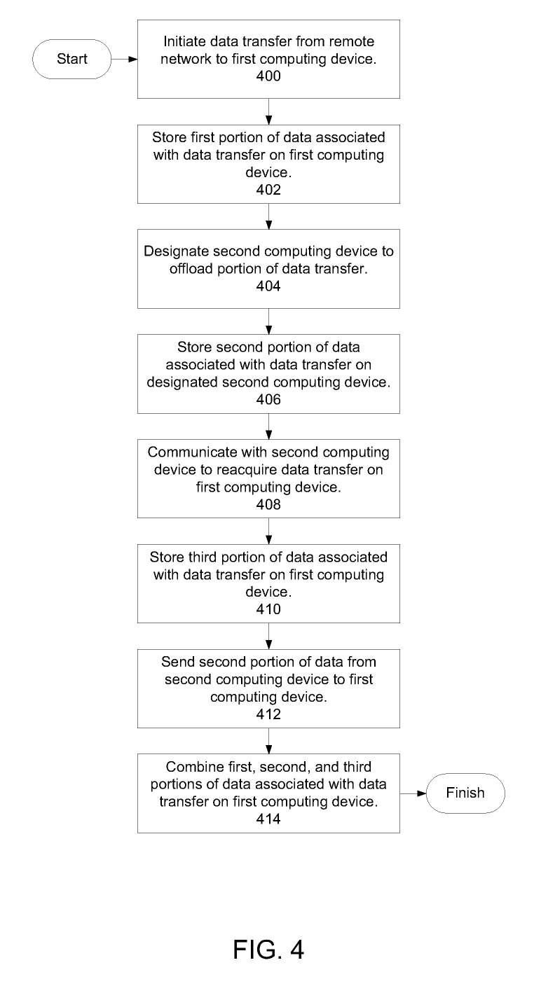

FIG. 4 illustrates a flow diagram of yet another embodiment of a process to offload a portion of a data transfer from a first computer to a remote network. The process may be performed by processing logic that is comprised of hardware, software, or a combination of both. Turning now to FIG. 4, the process begins by processing logic initiating a data transfer from a remote network to a first computing device (processing block 400). In many embodiments, the data transfer is specifically between the first computing device, which may be coupled to a local network, and a remote computing device coupled to the remote network.

Processing logic then stores a first portion of the data associated with the data transfer on the first computing device (processing block 402). Processing block 402 takes place prior to any offload designation, thus this would be the standard process if no offloading occurred. Then processing logic designates a second computing device to offload a portion of the data transfer (processing block 404). Next, processing logic stores a second portion of the data on the designated second computing device (processing block 406). Again, at this point, different portions of the data associated with the data transfer are located on both the first and second computing devices.

Then processing logic communicates with the second computing device to reacquire the data transfer on the first computing device (processing block 408). In many embodiments, this may take place when a data transfer is initiated between a remote network and the first computing device, the first computing device stores a first portion of the data and then becomes unavailable. During the unavailability, the second computing device is utilized as a temporary storage space so the transfer can continue. Then, prior to the transfer finishing from the remote network, the first computing device returns to an available status. At this point, since the second computing had taken over with the temporary storage, a communication (e.g. a command) needs to be sent to the second computing device to tell it that there is no longer a need for further temporary storage and that the first computing device is again receiving the data transfer.

Thus, processing logic stores a third portion of the data on the first computing device (processing block 410). Additionally, since the first computing device is back up and available, processing logic then (or simultaneously with processing block 410) sends the second portion of the data that was temporarily stored within the second computing device to the first computing device (processing block 412). At this point, the first computing device has all three portions of the data. Therefore, processing logic then combines the first, second, and third portions of the data associated with the data transfer on the first computing device to have a complete set of the data associated with the data transfer (processing block 414) and the process is finished.

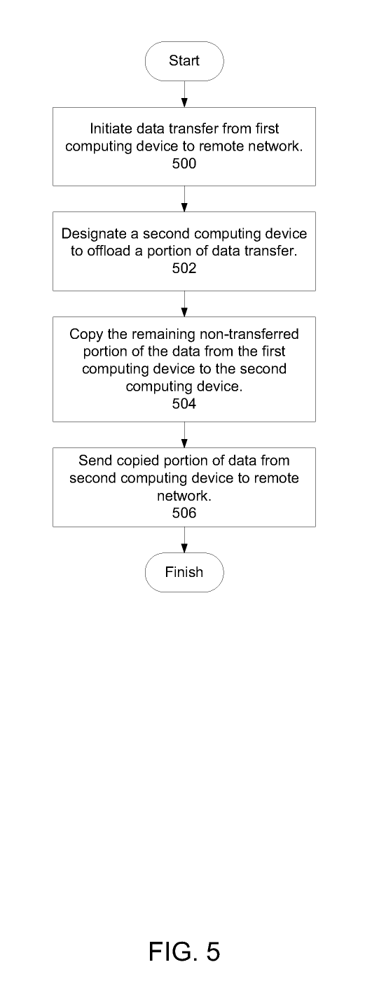

FIG. 5 illustrates a flow diagram of an embodiment of a process to offload a portion of a data transfer from a remote network to a first computer. The process may be performed by processing logic that is comprised of hardware, software, or a combination of both. Turning now to FIG. 5, the process begins by processing logic initiating a data transfer from a first computing device to a remote network (processing block 500). In many embodiments, the data transfer is specifically between the first computing device, which may be coupled to a local network, and a remote computing device coupled to the remote network.

Processing logic then designates a second computing device to offload a portion of the data transfer (processing block 502). In many embodiments, both the first and second computing devices are coupled to a local network. Next, processing logic copies any remaining non-transferred portion of the data from the first computing device to the second computing device (processing block 504). Finally, processing logic sends the copied portion of the data from the second computing device to the remote network (processing block 506) and the process is finished. In this scenario, once the entire remaining portion of the non-transferred data is copied to the second computing device, the first computing device then is free to perform whatever work it requires without any further requirement to participate in the remainder of the data transfer.

Thus, embodiments of a method, system, and computer readable medium for offloading data transfers in a networking environment are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
initiating a data transfer from a first computing device to a second computing device;
designating a third computing device to offload at least a portion of the data associated with the data transfer;
storing the offloaded portion of the data on the designated third computing device for a period of time; and
sending the data stored on the third computing device to the second computing device after the period of time.

2. The method of claim 1, wherein the first computing device is communicatively coupled directly to a first network, the second computing device is communicatively coupled directly to a second network, and the third computing device is communicatively coupled directly to the first and second networks.

3. The method of claim 2, further comprising:
querying the availability of the second computing device once the data transfer has completed; and
sending the stored data from the third computing device to the second computing device when the result of the query shows the second computing device as available.

4. The method of claim 3, wherein the second computing device is available when the second computing device is functional and approves receiving data from the data transfer.

5. The method of claim 2, further comprising:
querying whether the data transfer from the first computing device has completed; and
sending the stored data from the third computing device to the second computing device when the result of the query shows the data transfer has completed.

6. The method of claim 1, further comprising:
storing an initial portion of the data associated with the data transfer on the second computing device prior to the offload designation; and
after the offload designation occurs, sending the initial portion of the data associated with the data transfer from the second computer to the third computer.

7. The method of claim 1, further comprising:
deleting the stored data from the data storage unit after the first computing device receives the sent stored data.

8. A system, comprising:
a first computing device communicatively coupled to a local network and a remote network, the first computing device including
data transfer offloading logic to
initiate a data transfer between the first computing device and the remote network; and
designate a temporary alternative storage location for at least a portion of data associated with the data transfer; and
a second computing device communicatively coupled to the local network and the remote network, the second computing device including
a temporary alternative storage location to store data;
network intermediary storage logic to
store at least a portion of the data associated with the data transfer sent to the first computing device in the temporary alternative storage location for a period of time; and
send the stored data to the first computing device after the period of time.

9. The system of claim 8, wherein the network intermediary storage logic is further operable to:
query the availability of the first computing device once the data transfer has completed; and
send the stored data to the first computing device when the result of the query shows the first computing device as available.

10. The system of claim 9, wherein the first computing device is available when the first computing device is functional and approves receiving data from the data transfer.

11. The system of claim 8, wherein the data transfer offloading logic is further operable to:
query whether the data transfer from the remote network has completed; and
request the stored data from the temporary alternative storage location when the result of the query shows the data transfer has completed.

12. The system of claim 8, wherein the first computing device further includes a storage unit, the storage unit to store data.

13. The system of claim 12, wherein the first computing device is further operable to:
store an initial portion of the data associated with the data transfer in the storage unit; and
after the offload designation occurs, send the initial portion of the data associated with the data transfer to the temporary alternative storage location.

14. The system of claim 13, wherein the network intermediary storage logic is further operable to:
receive the data associated with the initial portion of the data transfer from the first computer system;
combine the data associated with the initial portion of the data transfer with the data associated with the stored portion of the data transfer; and
store the combined data in the temporary alternative storage location.

15. The system of claim 8, wherein the network intermediary storage logic is further operable to:
delete the stored data from the temporary alternative storage location after the first computing device receives the sent stored data.

16. A computer readable medium having embodied thereon instructions, which when executed by a computer, results in the computer performing a method comprising:
initiating a data transfer from a first computing device, communicatively coupled directly to a first network, to a second computing device, communicatively coupled directly to a second network;
designating a third computing device, communicatively coupled directly to the first and second networks, to offload at least a portion of the data associated with the data transfer;
storing the offloaded portion of the data on the designated third computing device for a period of time; and
sending the data stored on the third computing device to the second computing device after the period of time.

17. The computer readable medium of claim 16, wherein the performed method further comprises:
sending the data stored on the third computing device to the second computing device when the second computing device approves of a subsequent data transfer between the third computing device and the second computing device.

18. The computer readable medium of claim 16, wherein the performed method further comprises:
deleting the stored data from the data storage unit after the first computing device receives the sent stored data.

19. The computer readable medium of claim 16, wherein the performed method further comprises:
storing the portion of data associated with the data transfer after an initial portion of the data transfer has already been completed between the first computer system and the second computer system.

20. The computer readable medium of claim 19, wherein the performed method further comprises:
sending the data associated with the initial portion of the data transfer from the first computer system to the second computer system;
combining the data associated with the initial portion of the data transfer with the data associated with the stored portion of the data transfer; and
storing the combined data on the second computer system.
